(19) United States
(12) Patent Application Publication
(10) Pub. No.: US 2026/0200437 A1
(43) Pub. Date: Jul. 16, 2026

(54) WIPER ACTUATING LINKAGE SYSTEM

(71) Applicant: VALEO SYSTEMES D'ESSUYAGE, La Verriere (FR)

(72) Inventors: Antoni SPIECHA, La Verriere (FR); Przemyslaw SZYMANEK, La Verriere (FR); Karol CHRUPCZALSKI, La Verriere (FR)

(73) Assignee: VALEO SYSTEMES D'ESSUYAGE, La Verriere (FR)

(21) Appl. No.: 19/134,820

(22) PCT Filed: Nov. 28, 2023
(86) PCT No.: PCT/EP2023/083337

§ 371 Date: Jun. 2, 2025

(30) Foreign Application Priority Data
Dec. 2, 2022 (EP) 22211228.6

(51) Int. Cl. B60S 1/24; F16C 11/06

(52) U.S. Cl. CPC B60S 1/24; F16C 11/06

(57) ABSTRACT

The present invention relates to a wiper actuating linkage system for a windscreen wiper system, comprising at least one connecting rod (201) extending between longitudinal ends (203, 205) thereof; and at least one crank, wherein a longitudinal end of the at least one connecting rod (201) is articulated to the at least one crank (207) by means of a ball socket assembly comprising a socket (209) and a ball stud (211) which is configured to be secured to the crank (207), the socket (209) comprising a body portion (215) configured to receive a ball portion (217) of the ball stud (211) therein, and the socket (209) further comprises at least one locking slot (227) receiving a locking means (213) for retaining the ball portion (217) inside the socket (209).

### TECHNICAL FIELD

The present invention relates to a windscreen wiper actuating linkage system. More particularly, the present invention relates to a ball socket assembly for joining a connecting rod of the windscreen wiper actuating linkage system, and to a method of assembly of a connecting rod to the windscreen wiper actuating linkage system.

### BACKGROUND OF THE INVENTION

A windscreen wiper system is generally used on motor vehicles to clean a windscreen of the vehicle. The windscreen wiper system comprises a drive unit and a wiper actuating linkage system, which transforms the rotational motion of the drive unit to a reciprocating motion of at least one wiper arm. Wiper blades are attached to the wiper arms for wiping the windscreen of the vehicle. Conventionally, the wiper actuating linkage system comprises one or more link rods or connecting rods, one or more cranks, and one or more pivot assemblies. Each longitudinal end of the connecting rods are articulated to a corresponding crank by means of a ball-and-socket mechanism, for example.

Conventionally, the ball-and-socket joints are assembled when the windscreen wiper system is assembled. This generally means that the socket, attached to or otherwise incorporated in a connecting rod, is pressed onto a corresponding ball, attached to or otherwise incorporated in a crank arm. This generally requires power-assisted (i.e. hydraulic or pneumatic) tools, for instance a press, and as such is generally performed before the windscreen wiper system is mounted to the vehicle.

It is also common that the windscreen wiper systems known in the art further comprise a frame tube or other such supporting structure, for supporting the pivot assemblies and the wiper motor and maintaining their positions relative to each other.

Components of the known windscreen wiper actuating linkage system are arranged in such a way that the overall windscreen wiper actuating linkage system may be delivered to customers as a unitary piece for mounting it onto a vehicle. However, in order to reduce the transportation cost and ease the assembly process, it may be necessary to deliver two pivot assemblies separately, with the consequence that the linkage elements of the windscreen wiper system must be assembled after mounting to the vehicle.

Consequently, in order to perform the mounting of the ball-and-socket joints as described above, the assembly-line worker is obligated to use power tools, for instance a pneumatically-operated pincers, to apply the force required for assembling the joint. This is cumbersome and time-consuming, particularly in an assembly-line environment.

### SUMMARY OF THE INVENTION

It is therefore an object of the present invention to provide a wiper actuating linkage system which resolves, or at least alleviates, at least some of the drawbacks of the prior art described above.

More precisely, an object of the present invention is to provide a wiper actuating linkage system in which a connecting rod is fixed to a drive crank by way of a ball-and-socket joint without requiring the use of tools.

Another object of the present invention is to provide a wiper actuating linkage system, which facilitates easy assembly of the wiper actuating linkage system onto a motor vehicle, while reducing number of components of the wiper actuating linkage system.

Another object of the present invention is to provide a wiper actuating linkage system, in which pivot assemblies of the wiper actuating linkage system can be easily connected with each other without employing any tools such that the pivot assemblies can be delivered as two different components to a customer.

To this end, the present invention is directed towards a wiper actuating linkage system of a windscreen wiper system, comprising at least one connecting rod extending between longitudinal ends thereof, and at least one crank, a longitudinal end of the at least one connecting rod articulated to the at least one crank by means of a ball socket assembly comprising a socket and a ball stud which is configured to be secured to the crank.

According to the invention, the socket comprises a body portion intended to receive a ball portion of the ball stud therein, and the socket further comprises at least one locking slot configured to receive a locking means for retaining the ball portion inside the socket.

Advantageously, with the configuration of the ball socket assembly of the present invention, it is possible to assemble the connecting rod to the crank without employing any clamping devices or tools, i.e. by the assembly-line worker using only his/her bare hands.

Further, as the connecting rod is articulated to the crank manually and without requiring the use of any tools, it is possible that pivot assemblies of the linkage system can be easily connected with each other by manually assembly. Consequently, the components of the wiper actuating linkage system can be delivered as loose components to a customer that are assembled on the vehicle on the final assembly line, rather than installed as a single, difficult-to-manipulate subassembly requiring complex, expensive, and cumbersome tools for assembly and mounting.

Preferably, the body portion comprises a substantially-spherical internal cavity with a closed first end and an open second end opposite to the closed first end, the internal cavity receiving the ball portion of the ball stud.

Preferably, the socket comprises a mobile first segment and a fixed second segment, the first and second segments together constituting the body portion.

Preferably, the first segment of the body portion has a reduced thickness compared to a second segment of the body portion.

The first segment is thus configured to be capable of deflecting back and forth in a radial direction, thereby facilitating easy assembly of the connecting rod and the crank. In other words, the operator may simply push the connecting rod onto the ball portion with his hand, and the ball portion causes the first segment to flex outwards, thereby receiving the ball portion inside the socket without using any tools.

In a possible variant, the locking means comprises an elongated member and an stop member extending from the elongated member at an extremity thereof.

Upon insertion into the socket, the locking means prevents the outward movement of the snap fitting portion, i.e., the first zone, once the ball portion is received inside the housing of the socket, thereby securely retaining the ball stud inside the socket.

Preferably, the at least one locking slot is arranged adjacent to the body portion, and extends along an outer periphery of the snap fitting portion of the body portion.

According to a possible embodiment, the at least one locking slot has a form complementary to a form of the elongated member.

According to a possible variant, the first segment is configured to deform radially outward from a resting position during the assembly and/or disassembly of the ball portion with the socket.

According to a possible variant, the stop member of the locking means is configured to abut against a stop surface of the socket when the elongated member is completely inserted into the at least one locking slot.

In this way, both the first segment of the body portion and the locking means are substantially immobilized; the abutment of the locking means against the stop surface preventing the disengagement of the locking means and consequently the liberation of the first segment.

According to a possible variant, the at least one locking slot is formed as a through hole or a blind hole.

According to a possible variant, the socket is overmolded onto a longitudinal end of the at least one connecting rod.

According to a possible variant, the closed first end of the socket and the stop member of the locking means are substantially flush when the locking means is inserted into the at least one locking slot.

According to a second aspect, the invention is directed towards a windscreen wiper device comprising the wiper actuating linkage system according to the foregoing.

According to a third aspect, the invention is directed towards a vehicle comprising the windscreen wiper device according to the foregoing.

According to a fourth aspect, the invention is directed to a method of assembling a connecting rod and a crank of a wiper actuating linkage system according to the foregoing description, comprising the steps of inserting the ball portion of the crank into the socket of the connecting rod, such that the mobile first segment of the body portion is displaced radially outwards as the ball portion is received inside the body portion of the socket, and retaining the ball portion within the internal cavity by inserting an elongated portion of a locking means into the at least one locking slot, such that the mobile first segment of the body portion is blocked from being displaced radially outwards.

Further advantages, features and details of the invention will be apparent from the following description of preferred embodiments of the invention and from the drawings.

### BRIEF DESCRIPTION OF DRAWINGS

To complete the description and to provide a better understanding of the invention, a set of drawings is provided. Said drawings form an integral part of the description and illustrate an embodiment of the invention, which should not be construed as restricting the scope of the invention, but only as an example of how the invention can be carried out. The drawings comprise the following characteristics:

FIG. 1 shows a perspective view of a wiper module having a wiper actuating linkage system, in particular comprising a frame tube, according to the prior art;

FIG. 2 shows an exploded view of a wiper actuating linkage system, comprising a connecting rod, a ball socket assembly, a crank, and a locking means, according to an embodiment of the present invention;

FIG. 3a shows a perspective view of the socket of the ball socket assembly of the wiper actuating linkage system of FIG. 2;

FIG. 3b shows a perspective bottom view of the socket of FIG. 3a;

FIG. 4a shows a perspective view of the ball stud of the ball socket assembly of the wiper actuating linkage system of FIG. 2;

FIG. 4b shows a perspective view of the locking means of the wiper actuating linkage system of FIG. 2;

FIG. 5a shows a perspective view of the wiper actuating linkage system of FIG. 2 in an assembled, locked configuration;

FIG. 5b shows a perspective view of the wiper actuating linkage system of FIG. 2 in an assembled, unlocked configuration; and

FIG. 5c shows a cross-sectional view of a portion of the assembly shown in FIG. 5b, according to an embodiment of the present invention.

### DETAILED DESCRIPTION OF THE INVENTION

The description set forth below in connection with the appended drawings is intended to serve as an illustrative description of one or more exemplary embodiment(s) of the disclosed subject matter, and is not necessarily intended to represent the only embodiment(s) of the invention, nor present it/them in a limiting manner.

Moreover, in certain instances, the description includes specific details for the purpose of providing an understanding of the disclosed subject matter. However, it will be apparent to those skilled in the art that embodiments may be practiced without these specific details. In some instances, well known structures and components may be shown in simplified or schematic form, or omitted entirely, in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

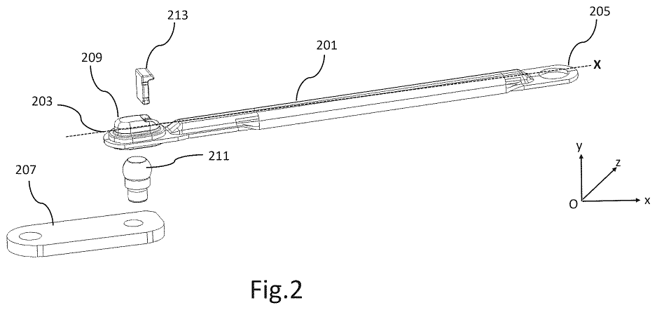

In the following description, the longitudinal, vertical or transverse denominations refer to the orientation of a connecting rod of a wiper actuating linkage system. The longitudinal direction corresponds to a direction of longitudinal extension of the connecting rod, this longitudinal direction being parallel to an axis Ox of an orthonormal reference, for example represented in FIG. 2. The transverse direction corresponds to a direction parallel to an Oy axis of this orthonormal frame, the axis Oy being perpendicular to the axis Ox. A vertical direction corresponds to a direction parallel to an axis Oz of the orthonormal coordinate system, the axis Oz being perpendicular to the axis Ox and the axis Oy.

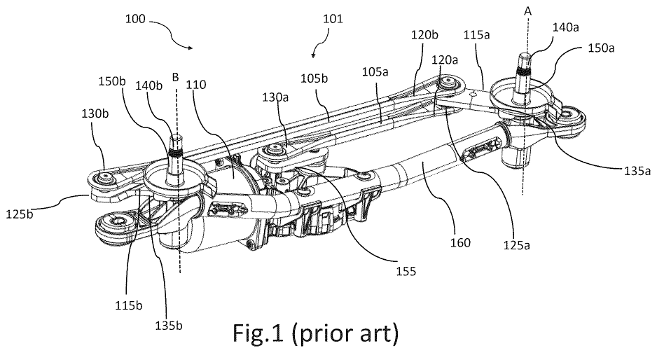

A windscreen wiper system is generally used on motor vehicles to clean a windscreen of the vehicle, for instance to remove rainwater, dust, etc. that may accumulate on the windscreen over the normal course of use of the vehicle. FIG. 1 shows a perspective view of an exemplary wiper module having a wiper actuating linkage system according to prior art.

The windscreen wiper system comprises a wiper module 100 shown in detail in FIG. 1. The wiper module 100 comprises a drive unit and a wiper actuating linkage system 101, which transfers drive from a wiper motor 110 of the drive unit to a pair of wiper arms (not shown in Figures), providing reciprocating movement of the wiper arms. Wiper blades (not shown in Figures) are attached to the wiper arms for wiping a windscreen of the vehicle. The wiper blades are placed in abutment with the windscreen, such that the wiper blades are capable of wiping the windscreen of a vehicle. The wiper actuating linkage system 101 is provided for moving the wiper arms between a first limit of its trajectory near the bottom of the windscreen (sometimes referred to as the “in-wipe position”) and a second limit of its trajectory (sometimes referred to as the “out wipe position”). Optionally, some embodiments may also be capable of moving the wiper arms to a third, storage position upon deactivation of the system, sometimes referred to as the “park position.”

The wiper actuating linkage system 101 comprises a first connecting rod 105a transferring a drive from the wiper motor 110 to a first driving crank 115a and via a second connecting rod 105b to a second driving crank 115b. One longitudinal end 120a of the first connecting rod 105a is linked to a second end 125a of the first driving crank 115a. Further, one longitudinal end 120b of the second connecting rod 105b is linked to the second end 125a of the first driving crank 115a. The other longitudinal end 130b of the second connecting rod 105b is linked to a second end 135b of the second driving crank 115b.

A first wiper arm (not shown in Figures) is fixed to a first pivot shaft 140a and the second wiper arm (not shown in Figures) is fixed to a second pivot shaft 140b. The reciprocating motion of the two connecting rods 105a, 105b is transferred via the pivot shafts 140a, 140b into a reciprocating movement of the first wiper arm and the second wiper arm. The first wiper arm rotates about the rotational axis A of the first pivot shaft 140a and the second wiper arm rotates about the rotational axis B of the second pivot shaft 140b.

The wiper actuating linkage system 101 presented in FIG. 1 further comprises a first pivot shaft housing 150a and a second pivot shaft housing 150b. The first pivot shaft housing 150a and the second pivot shaft housing 150b support the first pivot shaft 140a and a second pivot shaft 140b, respectively. The first pivot shaft 140a has a first rotational axis A around which the first pivot shaft 140a rotates in the first pivot shaft housing 150a. The second pivot shaft 140b has the second rotational axis B around which the second pivot shaft 140b rotates in the second pivot shaft housing 150b.

The first pivot shaft 140a is fixed to the first end 135a of the first driving crank 115a and the second pivot shaft 140b is fixed to the first end 135b of the second driving crank 115b. The wiper motor 110 is coupled with the windscreen wiper drive linkage 101 via a coupling element 155. The coupling element 155 is linked to the second longitudinal end 130a of the first connecting rod 105a.

The wiper module 100 further comprises a frame tube 160 for supporting the first pivot shaft housing 150a, the second pivot shaft housing 150b and the wiper motor 110. In particular, the wiper motor and the first and second pivot shaft housings 150a, 150b are permanently fixed to the frame tube 160.

The first connecting rod 105a and the second connecting rod 105b driven by the wiper motor 110 to perform a reciprocating linear movement. The reciprocating linear movement of the second connecting rod 105b is transferred into a reciprocating movement of the second driving crank 115b. The movement of the second connecting rod 105b towards the second driving crank 115b causes a rotation of the second driving crank 115b about the rotational axis B of the second pivot shaft 140b. Accordingly, the reciprocating linear movement of the first connecting rod 105a is transferred into a reciprocating movement of the first driving crank 115a. The first driving crank 115a rotates about the rotational axis A of the first pivot shaft 140a.

Thus, in the wiper actuating linkage systems known in the prior art, the various different components thereof are arranged in such a way that the overall windscreen wiper actuating linkage system may be delivered to customers as a single, preassembled, indivisible piece, ready for mounting onto a vehicle.

The assembly of these components is generally done at the time of fabrication of the wiper actuating linkage system, and consequently employ techniques in their assembly that can generally only be accomplished with the use of large, cumbersome, and/or non-portable tools. This is particularly the case for the ball and socket joints used on the connecting rods, whose assembly requires high levels of clamping force applied by e.g. a hydraulic press. Such tools are, in any case, unsuited for use on a vehicle final assembly line.

Therefore, according to an exemplary embodiment of the present invention, a wiper actuating linkage system in provided in which a connecting rod is assembled to a drive crank, without requiring the use of any additional tools.

For the purpose of brevity, an explanation is provided herein by referring to a single connecting rod. However, it is understood to a person skilled in the art, the explanation provided herein is also applicable to wiper actuating linkage systems where multiple connecting rods are employed. Likewise, for the purpose of brevity, an explanation is provided herein by referring to a single drive crank. However, it is understood to a person skilled in the art, the explanation provided herein is also applicable to wiper actuating linkage systems comprising multiple drive cranks, and equally to such cranks as attached to a pivot shaft or to a wiper motor output shaft.

FIG. 2 shows an exploded view of a connecting rod, a ball socket assembly, a crank, and a locking means of a wiper actuating linkage system, according to an embodiment of the present invention. In particular, FIG. 2 illustrates the connecting rod 201 extending along a longitudinal axis X between a first longitudinal end 203 and a second longitudinal end 205, the crank 207 configured to be assembled with the connecting rod 201, the ball socket assembly comprising a socket 209 and a ball stud 211, and the locking means 213. Each of the above components will be described in greater detail below.

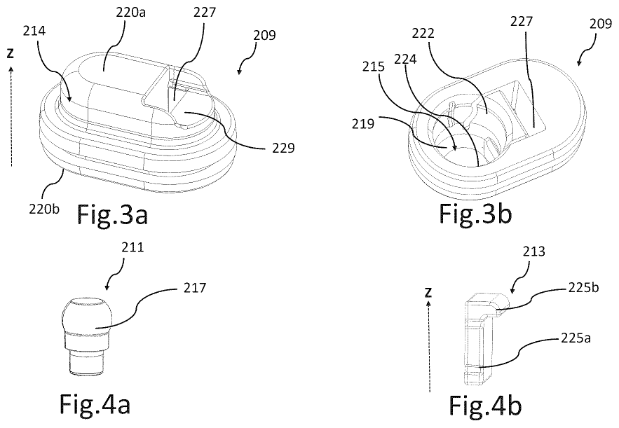

FIG. 3a shows a perspective view of a socket of a ball socket assembly of a wiper actuating linkage system, according to an embodiment of the present invention. FIG. 3b shows a perspective bottom view of the socket shown in FIG. 3a, according to an embodiment of the present invention.

In one possible configuration, the socket 209 is configured to be over molded onto a recess portion provided at the first longitudinal end 203 and/or the second longitudinal end 205 of the connecting rod 201. In another possible configuration, the socket 209 and the connecting rod 201 may be provided as individual components that are subsequently assembled together.

Further, the socket 209 of the present invention may optionally be made from a low friction material (for instance a low-friction polymer such as PTFE or an oil-impregnated polymer such as PET or Nylon), which does not require the application of additional grease to the socket 209 prior to assembly. In addition, as can be seen in FIG. 2, the socket 209 is designed to extend along the longitudinal axis X, which is in line with an axis of the connecting rod 201. This particular design of the socket 209 helps to minimize the overall width of the connecting rod 201.

The socket 209 globally comprises a housing 214 (shown in FIG. 3a) for receiving a ball of the ball-and-socket joint. In the illustrated embodiment, the housing is constituted by the body portion 215 (shown in FIG. 3b). The body portion 215 cooperates with a ball portion 217 of the ball stud 211, by receive the ball portion 217 therein.

To this end, the body portion 215 comprises an internal cavity 219 (shown in the FIG. 3b) with a closed first end 220a (shown in FIG. 3a) and an open second end 220b (shown in the FIG. 3b) opposite the closed first end 220a. As can be seen in FIG. 3, the body portion extends along an axis Z perpendicular to the longitudinal axis X. That is to say, the body portion is defined along the vertical axis Z. Further, the internal cavity 219 of the body portion 215 is dimensioned to receive and cooperate with the ball portion 217 of the ball stud 211. By way of a non-limiting example, the internal cavity is of a generally spherical shape in order to cooperate with the spherical shaped ball portion 217 of the ball stud 211.

The socket 209 comprises means for accommodating the insertion and removal of the ball portion 217 of the ball stud 211. To that end, the socket 209 comprises a first zone 222 (shown in FIG. 3b) of the body portion 215, extending over an angular sector of the body portion 215. The remaining portion of the body portion 215 is referred as a second zone 224. The first zone 222 and the second zone 224 thus together constitute the body portion 215.

The first zone 222 of the body portion 215 has a reduced thickness, as compared to the second zone 224, and is so configured to be capable of deforming or flexing in a radial direction from its rest position under the application of force, in particular during the assembly and/or disassembly of the ball portion 217 to the socket 209. In particular, it will be seen that the first zone may flex along a longitudinal axis of the socket 209 when the snap fitting portion extends along a transverse axis, i.e., perpendicular to the longitudinal axis of the socket 209.

In the present embodiment, the first zone 222 and second zone 224 are delimited from each other by slits or notches formed in the body portion 215, as visible in FIG. 3b. This is advantageous in that it obtains a maximum degree of flexibility in the first zone 222. However, it may be preferable in other embodiments to form the first zone 222 integrally with the second zone 224.

In an aspect, the socket 209 further comprises at least one locking slot, for example the locking slot 227 extending along the vertical axis Z. In one example, the at least one locking slot 227 may be arranged adjacent to the body portion 215, and extends along an outer periphery of the first zone 222 of the body portion 215. In one example, the at least one locking slot 227 is formed as a blind hole. In another example, the at least one locking slot 227 is formed as a through hole.

According to an embodiment of the present invention, the socket 209 further comprises a locking means 213 shown in FIG. 4b, which is configured to securely hold the ball portion 217 inside the housing 214, as will be described in the following paragraphs.

The locking means 213 includes an elongated member 225a and a stop member 225b extending from the elongated member 225a at one of it ends. As can be seen in FIG. 4a, the elongated member 225a extends along the vertical axis Z. The at least one locking slot 227 has a shape complementary to a shape of the elongated member 225a such that the at least one locking slot 227 receives the elongated member 225a of the locking means 213.

The locking means 213 may be retained in the locking slot 227 by friction and/or a simple interference fit. Alternatively, it may be preferable to employ positive retention means (e.g. detents, locking pins, or safety wire) to ensure an undesired disassembly of the joint.

When the locking slot 227 is empty, the first zone 222 of the body portion 215 may freely deflect radially outwards, thus permitting the complete insertion of the ball portion 217 of the ball stud 211 into the socket 209.

However, once the locking means 213 is inserted into the locking slot 227, the locking means 213 blocks the outward movement of the first zone 222. Thus, once the ball portion 217 is received inside the socket 209, inserting the locking means 213 into the locking slot 227 blocks the first zone 222 from deflecting radially outwards. As the first zone 222 can no longer deform radially outwards, the ball portion 217 is effectively blocked within the socket 209. In this manner, the ball and socket joint between the connecting rod 201 and the crank 207 is effectively secured.

Further, an operator may use the stop member 225b to hold the locking means 213 during the assembly and the disassembly of the locking means 213, and additionally to serve as a pressing surface against which an assembly-line worker can apply a force. In such embodiments, the socket 209 may further comprise a stop surface 229, and the stop member 225b of the locking means 213 is configured to abut against the 229 of the socket 209 when the elongated member 225b is completely inserted into the at least one locking slot 227. In particular, the stop surface 229 may be made complementary to the shape of the stop member 225b, so as to reinforce the retention of the locking means 213 and provide a clean visual aspect.

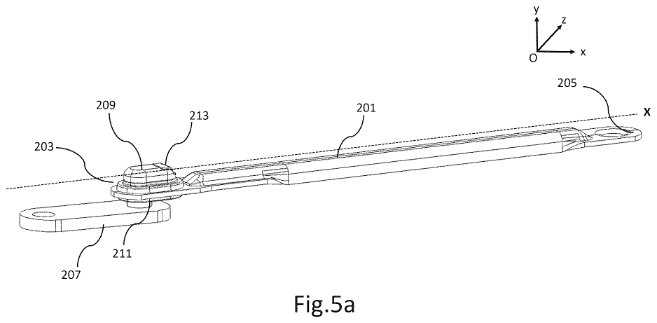

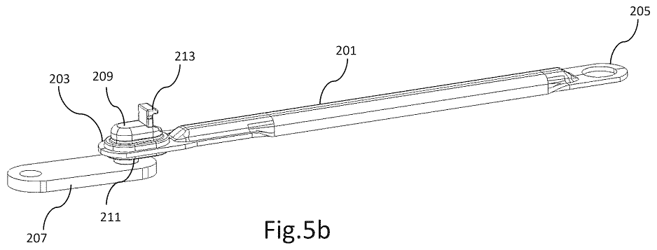

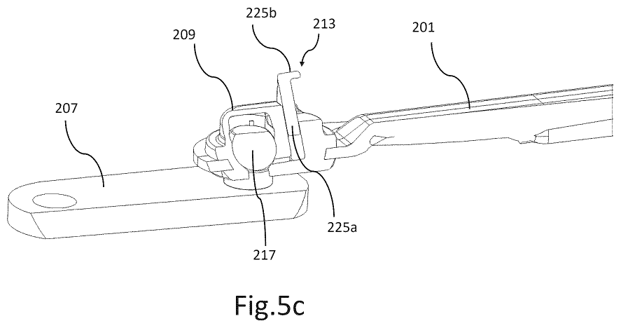

FIG. 5b shows a perspective view of a connecting rod assembled to a crank of a wiper actuating linkage system by means of a ball socket assembly and a locking means disposed in a locked position, according to an embodiment of the present invention. FIG. 5b shows a perspective view of a connecting rod assembled to a crank of a wiper actuating linkage system by means of a ball socket assembly and a locking means, which is disposed in an unlocked position, according to an embodiment of the present invention. FIG. 5c shows a cross-sectional view of a portion of the assembly shown in FIG. 5b, according to an embodiment of the present invention.

During the assembly of the connecting rod 201 onto the ball stud 211 of the crank 207, the connecting rod 201 is mounted onto the ball portion 217 provided on the crank 207 by placing the socket 209 provided at the longitudinal end of the connecting rod 201 on the ball portion 217. The first zone 222 of the body portion 215 deflects radially outwards as the ball portion 217 is received inside the internal cavity 219.

Once the ball portion 217 is fully received inside the internal cavity 219, the first zone 222 will, by virtue of its elasticity, revert to its initial position; however, the ball portion 217 is not secured inside the socket 209, despite the generally spherical form of the internal cavity 219, because the first zone 222 is at this point still free to deflect radially outwards and let the ball portion 217 exit the socket 209.

Subsequently, the ball portion 217 is retained securely inside the socket 209 by locking the ball socket connection using the locking means 213. The locking means 213 is inserted into the locking slot 227, such that the elongated member 225a of the locking means 213 is completely received inside the locking slot 227. As can be seen in FIG. 5c, the presence of the elongated member 225a of the locking means 213, once fully inserted into the locking slot 227, will block the first zone 222 from being able to deflect radially outwards, thereby preventing the escape of the ball portion 217 of the ball stud 211 from the socket 209.

Preferably, the closed end 220a of the socket 209 and the stop member 225b of the locking means 213 are at substantially same level when the elongated member 225a of the locking means 213 is completely inserted into the at least one locking slot 227, as can be seen in FIG. 5b.

Advantageously, with the configuration of the ball socket assembly of the present invention, an operator at the assembly line can easily assemble and disassemble the connecting rod 201 and the crank 207 without employing any clamping devices or tools; the worker need only place the socket 209 of the connecting rod 201 upon the ball portion 217 of the ball stud 211 and drive the locking means 213 home into the locking slot 227 with his/her bare hands.

Further, as the connecting rod 201 can be assembled manually without using any tools, it is possible that pivot assemblies of the linkage system can be easily connected with each other by manually assembling the connecting rod 201 and the crank 207. Thereby, pivot assemblies can be delivered to the customer as separate components, rather than as the single unitary wiper actuating linkage system of the prior art as illustrated in FIG. 1.

Consequently, the connecting rod can be manually assembled to the linkage system after the pivot assemblies are mounted individually onto the vehicle. Further, a frame tube or a supporting structure which supports the pivot assemblies and the wiper motor can be eliminated from the linkage system as the connecting rod and the crank can be assembled or disassembled independently of the pivot assemblies.

The person skilled in the art realizes that the present invention by no means is limited to the preferred embodiments described above. On the contrary, many modifications and variations are possible within the scope of the appended claims. In addition, the skilled person readily realizes that the different embodiments described herein may be combined freely to obtain new combinations.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantages.

LIST OF REFERENCE SIGNS

| | |
|---|---|
| 201 | Connecting rod |
| 203 | First longitudinal end |
| 205 | Second longitudinal end |
| 207 | Crank |
| 209 | Socket |
| 211 | Ball stud |
| 213 | Locking means |
| 214 | Housing |
| 215 | Body portion |
| 217 | Ball portion |
| 219 | Internal cavity |
| 220a | Closed end |
| 220b | Open end |
| 222 | First segment |
| 224 | Second segment |
| 225a | Elongated member |
| 225b | Stop member |
| 227 | Locking slot |
| 229 | Stop surface |

What is claimed is:

1. A wiper actuating linkage system of a windscreen wiper system, comprising
at least one connecting rod extending between longitudinal ends thereof; and
at least one crank, wherein a longitudinal end of the at least one connecting rod is articulated to the at least one crank by means of a ball socket assembly including a socket and a ball stud which is configured to be secured to the crank,
wherein the socket includes a body portion configured to receive a ball portion of the ball stud therein, and at least one locking slot receiving a removable locking means for retaining the ball portion inside the socket.

2. The wiper actuating linkage system as claimed in claim 1, wherein the body portion includes a substantially-spherical internal cavity with a closed first end and an open second end opposite to the closed first end, the internal cavity receiving the ball portion of the ball stud.

3. The wiper actuating linkage system as claimed in claim 1, wherein the socket includes a mobile first segment and a fixed second segment, the first and second segments together constituting the body portion.

4. The wiper actuating linkage system as claimed in claim 3, wherein the first segment of the body portion has a reduced thickness compared to a second segment of the body portion.

5. The wiper actuating linkage system as claimed in claim 1, wherein the locking means includes an elongated member and an stop member extending from the elongated member at an extremity thereof.

6. The wiper actuating linkage system as claimed in claim 1, wherein the at least one locking slot is arranged adjacent to the body portion, and extends along an outer periphery of the first segment of the body portion.

7. The wiper actuating linkage system as claimed in claim 5, wherein the at least one locking slot has a form complementary to the form of the elongated member.

8. The wiper actuating linkage system as claimed claim 3, wherein the first segment is configured to deform radially outward from a resting position during the assembly and/or disassembly of the ball portion with the socket.

9. The wiper actuating linkage system as claimed in claim 5, wherein the stop member of the locking means is configured to abut against a stop surface of the socket when the elongated member is completely inserted into the at least one locking slot.

10. The wiper actuating linkage system as claimed in claim 1, wherein the at least one locking slot is formed as a through hole or a blind hole.

11. The wiper actuating linkage system as claimed in claim 1, wherein the socket is overmolded onto a longitudinal end of the at least one connecting rod.

12. The wiper actuating linkage system as claimed in claim 2, wherein the closed first end of the socket and a stop member of the locking means are substantially flush when the locking means is inserted into the at least one locking slot.

13. A windscreen wiper system for a vehicle comprising a wiper actuating linkage system, the wiper actuating linkage system includes at least one connecting rod extending between longitudinal ends thereof, and at least one crank, wherein a longitudinal end of the at least one connecting rod is articulated to the at least one crank by means of a ball socket assembly including a socket and a ball stud which is configured to be secured to the crank, wherein the socket includes a body portion configured to receive a ball portion of the ball stud therein, and at least one locking slot receiving a removable locking means for retaining the ball portion inside the socket.

14. (canceled)

15. A method of assembling a connecting rod and a crank of a wiper actuating linkage system, the method comprising:
inserting a ball portion of the crank into a socket of a connecting rod, such that a mobile first segment of a body portion is displaced radially outwards as the ball portion is received inside the body portion of the socket; and
retaining the ball portion within an internal cavity by inserting an elongated portion of a locking means into the at least one locking slot, such that the mobile first segment of the body portion is blocked from being displaced radially outwards.
